(19) United States
(12) Patent Application Publication
(10) Pub. No.: US 2011/0161674 A1
(43) Pub. Date: Jun. 30, 2011

(54) DOCUMENT AUTHENTICATION USING DOCUMENT DIGEST VERIFICATION BY REMOTE SERVER

(75) Inventor: Wei MING, Cupertino, CA (US)

(73) Assignee: KONICA MINOLTA SYSTEMS LABORATORY, INC., Huntington Beach, CA (US)

(21) Appl. No.: 12/648,951

(22) Filed: Dec. 29, 2009

(51) Int. Cl. H04L 9/32; G06K 19/06; G06F 17/00; B41J 2/01

(52) U.S. Cl. 713/181; 235/494; 235/375; 347/107

(57) ABSTRACT

A method of generating a self-authenticating document while utilizing document digest stored on a server for verification purposes. Authentication information for the document is encoded in barcode which is printed on the document. A document digest is calculated from the authentication information and transmitted to a server to be stored. When authenticating a scanned copy of the document, the barcode is read to extract the authentication information. A target document digest is calculated from the extracted authentication information and transmitted to the server for verification. The server compares the target document digest with the previously stored document digest. If they are not the same, the barcode has been altered. If they are the same, the extracted authentication information is used to authenticate the scanned copy. A document ID may be generated and transmitted to the server, and used by the server to index or search for the stored document digest.

### BACKGROUND OF THE INVENTION

1. Field of the Invention

This invention relates to a document authentication method which uses barcodes to encode content of the document, and in particular, it relates to such a document authentication method which stores a short document digest on a server for verification purpose.

2. Description of Related Art

Barcode is a form of machine-readable symbology for encoding data, and has been widely introduced in a variety of application fields. Two-dimensional barcode (2d barcode) is one mode of such symbology. It can be used to encode text, numbers, images, and binary data streams in general, and has been used in identification cards, shipping labels, certificates and other documents, etc. Examples of widely used 2d barcode standards include PDF417 standard and QR Code®, and software and hardware products have been available to print and read such 2d barcodes.

Original digital documents, which may include text, graphics, images, etc., are often printed, and the printed hard copy are distributed, copied, etc., and then often scanned back into digital form. This is referred to as a closed-loop process. Authenticating a scanned digital document refers to determining whether the scanned document is an authentic copy of the original digital document, i.e., whether the document has been altered while it was in the hard copy form. Alteration may occur due to deliberate effort or accidental events. There are two approaches to authenticating a printed document. The first approach utilizes a database that stores original document images, and compares the scanned document image with the original image.

The second approach eliminates the dependency on a database of original images. In particular, methods have been developed to authenticate a printed document using two-dimensional (2d) barcode. Typically, such a method encodes the content of the original document, or other information extracted from the original document that can be used to authenticate the document (generally referred to as authentication information), in 2d barcode (referred to as authentication barcode). The barcode is printed on the same recording medium as the printed document, e.g., on the front or back side of the printed document or on a separate sheet. The content of the document may be a bitmap image of a page of the document, text, graphics or images contained within the document, or a mixture thereof. To authenticate a printed document bearing an authentication barcode, the document is scanned to obtain scanned data that represents the content of the document, e.g. a bitmap image, text extracted by using an optical character recognition (OCR) technology, etc. The authentication barcode is also scanned and the data contained therein (the authentication data) is extracted. The scanned data is then compared to the authentication data to determine if any part of the printed document has been altered since it was originally printed, i.e. whether the document is authentic. Some authentication technologies merely determine whether any alterations have occurred, some are able to determine what content has been altered and what the alterations are. A printed document bearing authentication barcode is said to be self-authenticating because generally no information other than what is on the printed document is required to authenticate its content.

### SUMMARY

In a self-authenticating document bearing 2d barcode that encodes authentication information, the barcode itself is vulnerable to alterations after the document is released. Accordingly, the present invention is directed to a document authentication method and related apparatus that substantially obviates one or more of the problems due to limitations and disadvantages of the related art.

An object of the present invention is to provide a document authentication method which generates a self-authenticating document, and at the same time utilizing document digest information stored on a server for verification purposes.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for generating a self-authenticating document, implemented in a system including a client computer and a server computer, which includes: on the client computer, (a) obtaining a source document; (b) generating authentication information based on a content of the source document; (c) generating a document digest from the authentication information; (d) transmitting a registration request containing the document digest to the server computer, wherein the registration request requests the server computer to store the document digest to be used for verification in a subsequent document authentication process; (e) generating an authentication barcode encoding the authentication information; (f) printing the source document and the authentication barcode on a sheet of recording medium; on the server computer, (g) receiving the registration request including the document digest from the client; and (h) storing the document digest in a database.

The method further includes: on the client computer, generating a document ID uniquely identifying the document; wherein in steps (d) and (g) the registration request further includes the document ID; and wherein step (h) further includes storing the document ID as an index or search key associated with the document digest in the database.

In another aspect, the present invention provides a method for authenticating a document, implemented in a system including a client computer and a server computer, the document including a document image and authentication barcode printed on a sheet of recording medium, the method including: on the client computer, (a) obtaining a scanned copy of the document including the document image and the authentication barcode; (b) extracting authentication information encoded in the authentication barcode; (c) generating a target document digest from the extracted authentication information; (d) transmitting a verification request containing the target document digest to the server computer, wherein the verification request requests the server computer to verify the target document digest based on previously stored document digests; on the server computer, (e) receiving the verification request including the target document digest from the client; (f) retrieving a corresponding stored document digest from a database; (g) comparing the target document digest with the retrieved document digest to determine whether the verification is successful; (h) transmitting a verification response to the client computer; on the client computer, (i) receiving the verification response from the server computer; (j) if the verification response indicates an unsuccessful verification, marking the document as having been altered; and (k) if the verification response indicates a successful verification, authenticating the document using the authentication information to determine whether the document has been altered.

The method further includes: (l) obtaining a document ID from the scanned document; wherein in steps (d) and (e) the verification request further includes the document ID; and wherein step (f) includes retrieving a stored document digest from the database using the document ID as an index or search key.

In another aspect, the present invention provides a computer program product that causes a data processing system to perform the above method.

It is to be understood that both the foregoing general description and the following detailed description are exemplary and explanatory and are intended to provide further explanation of the invention as claimed.

### BRIEF DESCRIPTION OF THE DRAWINGS

FIGS. 1 and 2 illustrate a process on a client computer and a process on a server computer, respectively, for generating a self-authenticating printed document according to an embodiment of the present invention.

FIGS. 3 and 4 illustrate a process on a client computer and a process on a server computer, respectively, for authenticating a self-authenticating printed document according to an embodiment of the present invention.

FIG. 5 schematically illustrates a system in which methods according to embodiments of the present invention may be implemented.

### DETAILED DESCRIPTION OF PREFERRED EMBODIMENTS

Embodiments of the present invention provides a method of generating a self-authenticating document, while utilizing document digest stored on a server for purpose of verification. More specifically, authentication information for the document is generated and encoded in barcode and the barcode is printed on the document. A document digest is calculated from the authentication information and transmitted to a server to be stored. When authenticating a scanned copy of the document, the barcode is read to extract the authentication information. A target document digest is calculated from the extracted authentication information and transmitted to the server for verification. The server compares the target document digest with the previously stored document digest to determine whether they are the same. If they are not the same, the barcode has been altered. If they are the same, the extracted authentication information is used to authenticate the scanned copy.

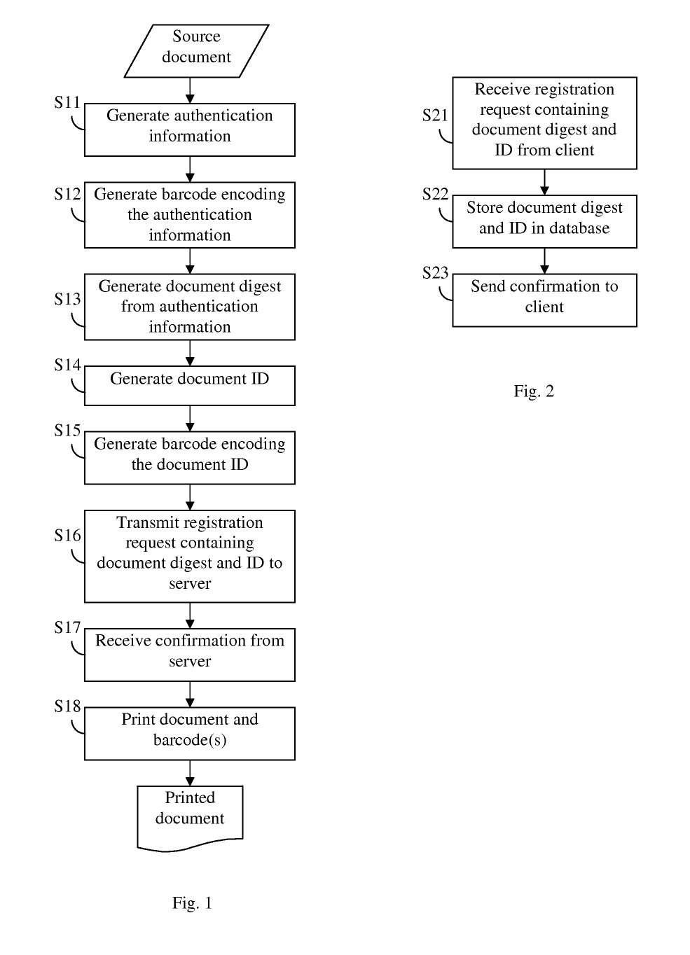

FIGS. 1 and 2 illustrate a process of generating a self-authenticating printed document and storing the document digest. FIG. 1 illustrates a process carried out by a first computer (referred to as a client computer for convenience), and FIG. 2 illustrates a process carried out by a second computer (referred to as a server computer for convenience). First, the client computer generates authentication information based on the content of the document to be printed (source document) (step S11). The authentication information may be, for example, compressed image data that represent an image of the source document, text data extracted from the source document, and/or other information descriptive of the source document. The authentication information may be encrypted. The authentication information is encoded in a barcode to be printed on the document itself (step S12). Steps S11 and S12 are generally known in the art.

The client computer also generates a document digest from the authentication information (step S13). One example of a document digest is a hash value calculated by hashing the authentication information. Other codes or descriptive information may be used as the document digest. The document digest preferably contains a relatively small amount of data. The resulting document digest is preferably a fixed length (e.g. 256, 512, 1024 bits, etc.) data string.

A document ID is also generated for the document (step S14). The document ID, which uniquely identifies the document, may be generated from information regarding the document (e.g. its filename or a file number), information regarding the human operator (e.g. a username or ID of the operator), information regarding the machine used to generate or print the document (e.g. a serial number of the machine), and/or time information (e.g. a time stamp), etc. The ID is encoded in a barcode (step S15), which may be the same as or different from the barcode generated in step S12. The barcode(s) generated in steps S12 and S15 may be collectively referred to as the authentication barcode.

The client computer transmits a registration request including the document digest and ID to the server computer (step S16). The registration request requests the server computer to store the document digest to be used for verification in a subsequent document authentication process. The registration request may be transmitted via email or a web application on the server. The document ID may be used as the title/subject of the email, the title of the web submission, or it may be transmitted as a part of the email or webpage content along with the document digest. Optionally, the document ID may be encrypted for security purposes.

On the server side, the server computer receives the registration request and extracts the document digest and ID (step S21). The document digest is stored in a database (step S22). The document ID is stored in association with the document digest; for example, the ID may be used as an index or search key when storing the document digest.

Preferably, the server transmits a confirmation to the client after successfully extracting and storing the document digest and ID (step S23).

On the client side, upon receiving the confirmation from the server (step S17), the document is printed for circulation, where the authentication barcode is printed with the document, e.g. on the front and/or back side of the same sheet of recording medium on which the document image is printed (step S18).

The order of some of the steps in FIG. 1 is not important. For example, steps S12 and S15 (generating barcodes) may be performed after step S16 or S17.

In the above embodiment, the document ID is generated by the client computer and transmitted to the server computer as a part of the registration request. Alternatively, the document ID may be assigned by the server computer and transmitted to the client computer, e.g., as a part of the confirmation. Further, instead of encoding the document ID in the barcode, the document ID may be printed on the document as plain text (e.g. in a footer).

The client and server computers are preferably different computers, but they may also be the same computer. For example, a central server may be used to store the digest information for many client computers located at distributed locations. If the client and server are the same computer, the steps of data transmission through email or web service can be replaced by an internal data communication process.

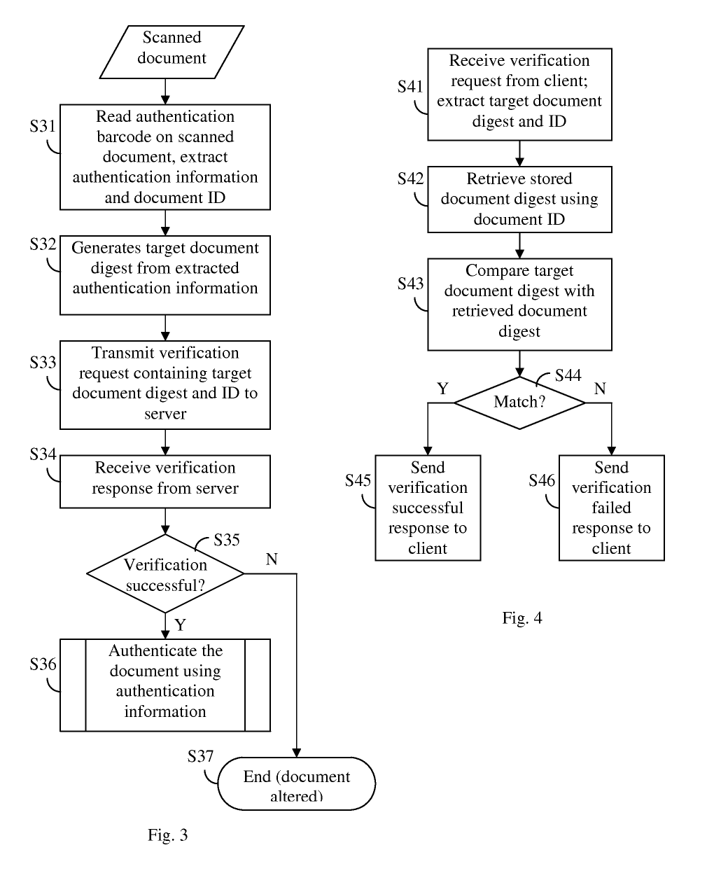

Later, a scanned document is presented for authenticating, which purports to be an authentic copy of the original printed document. FIGS. 3 and 4 illustrate a process of authenticating a scanned document. FIG. 3 illustrates a process carried out by a third computer (referred to as a client computer for convenience), and FIG. 4 illustrates a process carried out by the second computer (the server computer). The third computer may be the same or different from the first computer used to print the original document.

First, the client computer reads the authentication barcode on the scanned document and extracts the authentication information and document ID encoded therein (step S31). The client computer calculates a document digest (referred to as the target document digest) from the extracted authentication information using the same algorithm as in step S13 during the process of printing the original document (step S32). The target document digest and ID is transmitted to the server computer in a verification request (step S33). The verification request requests the server computer to verify the target document digest based on previously stored document digests. The verification request may be transmitted via email or a web application on the server. The document ID may be used as the title/subject of the email, the title of the web submission, or it may be transmitted as a part of the email or webpage content along with the document digest.

On the server side, upon receiving the verification request, the server computer extracts the target document digest and document ID contained therein (step S41). Using the document ID as an index or search key, the server computer retrieves the stored document digest corresponding to the ID from the database (step S42). The server computer then compares the retrieved document digest with the target document digest (step S43). If the two document digests are identical (“Y” in step S44), the server computer transmits a “verification successful” response to the client computer (step S45). If the two document digests are not identical, or if a document digest corresponding to the document ID does not exist in the database (“N” in step S44), the server computer transmits a “verification failed” response to the client computer (step S46).

On the client side, the client computer receives the verification response from the server (step S34). If a “verification failed” response is received (“N” in step S35), the document is marked as having been altered and the process terminates (step S37). If the response is a “verification successful” response (“Y” in S35), the client computer proceeds to authenticate the document using the authentication information extracted from the barcode (step S36). This step may be accomplished using known methods. In one such method, the authentication information represents an image of the document, and the image extracted from the authentication information is compared to the image of the scanned document. Based on the comparison, the client computer determines whether the scanned document has been altered. If the authentication information has been encrypted, it is decrypted first in step S36.

The authenticating method according to embodiments of the present invention described above has several advantages. Compared to a self-authentication method without any verification by the server, the above-described method is more secure as it can detect alterations made to the authentication barcode. Compared to a server-based authentication method in which the authentication information is stored on the server (rather than carried on the document itself), the above-described method achieves a similar result in the sense that the server retains certain verification function, but has the following advantages: It is less costly because the server need not store a large amount of authentication information and therefore can serve more clients; it is more efficient from a network traffic standpoint because only document digests, not the entire authentication information, is transferred over the network; and it offers better privacy because the authentication information (which is descriptive of the document content) is not transferred over the network.

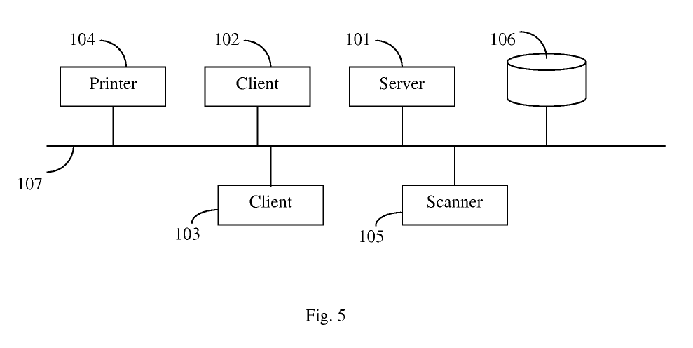

FIG. 5 illustrates a system on which the above described document authentication method may be implemented. The system includes a server computer 101, a client computer 102, a client computer 103, a printer 104, a scanner 105, and a mass storage device 106 connected via a network 107. The server computer 101 executes the server side process shown in FIGS. 2 and 4. Either client computer 102/103 can execute the client side process shown in FIG. 1 and the client side process shown in FIG. 3. Each computer includes a CPU that executes program code stored in a memory of the computer. The database is stored in the storage device 106. The printer 104 is used to print the document and the scanner 105 is used to scan the document to be authenticated. The printer 104 and the scanner 105 may also be all-in-one (“AIO”) devices that combine printing, scanning and copying functions. Furthermore, the functions performed by the client computer and/or the server computer described above may be integrated into a printer, scanner or AIO. Of course, the system shown in FIG. 5 is only exemplary, and any suitable system may be used to implement the methods described above.

It will be apparent to those skilled in the art that various modification and variations can be made in the document authentication method of the present invention without departing from the spirit or scope of the invention. Thus, it is intended that the present invention cover modifications and variations that come within the scope of the appended claims and their equivalents.

What is claimed is:

1. A method for generating a self-authenticating document, implemented in a system including a client computer and a server computer, comprising:
on the client computer,
(a) obtaining a source document;
(b) generating authentication information based on a content of the source document;
(c) generating a document digest from the authentication information;
(d) transmitting a registration request containing the document digest to the server computer, wherein the registration request requests the server computer to store the document digest to be used for verification in a subsequent document authentication process;
(e) generating an authentication barcode encoding the authentication information;
(f) printing the source document and the authentication barcode on a sheet of recording medium;
on the server computer,
(g) receiving the registration request including the document digest from the client; and
(h) storing the document digest in a database.

2. The method of claim 1, further comprising:
on the client computer, generating a document ID uniquely identifying the document;
wherein in steps (d) and (g) the registration request further includes the document ID; and
wherein step (h) further includes storing the document ID as an index or search key associated with the document digest in the database.

3. The method of claim 2, wherein in step (e) the authentication barcode further encodes the document ID.

4. The method of claim 1, wherein the document digest is a hash value.

5. The method of claim 1, wherein step (b) includes encrypting the authentication information.

6. A method for authenticating a document, implemented in a system including a client computer and a server computer, the document including a document image and authentication barcode printed on a sheet of recording medium, the method comprising:
on the client computer,
(a) obtaining a scanned copy of the document including the document image and the authentication barcode;
(b) extracting authentication information encoded in the authentication barcode;
(c) generating a target document digest from the extracted authentication information;
(d) transmitting a verification request containing the target document digest to the server computer, wherein the verification request requests the server computer to verify the target document digest based on previously stored document digests;
on the server computer,
(e) receiving the verification request including the target document digest from the client;
(f) retrieving a corresponding stored document digest from a database;
(g) comparing the target document digest with the retrieved document digest to determine whether the verification is successful;
(h) transmitting a verification response to the client computer;
on the client computer,
(i) receiving the verification response from the server computer;
(j) if the verification response indicates an unsuccessful verification, marking the document as having been altered; and
(k) if the verification response indicates a successful verification, authenticating the document using the authentication information to determine whether the document has been altered.

7. The method of claim 6, further comprising:
on the client computer, (l) obtaining a document ID from the scanned document;
wherein in steps (d) and (e) the verification request further includes the document ID; and
wherein step (f) includes retrieving a stored document digest from the database using the document ID as an index or search key.

8. The method of claim 7, wherein step (l) includes extracting the document ID from the authentication barcode.

9. The method of claim 6, wherein the document digest is a hash value.

10. The method of claim 6, wherein step (k) includes decrypting the authentication information.

11. A computer program product comprising a computer usable medium having a computer readable program code embedded therein for controlling a data processing system, the data processing system including a client computer and a server computer, the computer readable program code configured to cause the client computer to execute a first process and to cause the server computer to execute a second process,
wherein the first process comprises:
(a) obtaining a source document;
(b) generating authentication information based on a content of the source document;
(c) generating a document digest from the authentication information;
(d) transmitting a registration request containing the document digest to the server computer, wherein the registration request requests the server computer to store the document digest to be used for verification in a subsequent document authentication process;
(e) generating an authentication barcode encoding the authentication information;
(f) printing the source document and the authentication barcode on a sheet of recording medium;
wherein the second process comprises:
(g) receiving the registration request including the document digest from the client; and
(h) storing the document digest in a database.

12. The computer program product of claim 11,
wherein the first process further comprises generating a document ID uniquely identifying the document;
wherein in steps (d) and (g) the registration request further includes the document ID; and
wherein step (h) further includes storing the document ID as an index or search key associated with the document digest in the database.

13. The computer program product of claim 12, wherein in step (e) the authentication barcode further encodes the document ID.

14. The computer program product of claim 11, wherein the document digest is a hash value.

15. The computer program product of claim 11, wherein step (b) includes encrypting the authentication information.

16. A computer program product comprising a computer usable medium having a computer readable program code embedded therein for controlling a data processing system, the data processing system including a client computer and a server computer, the computer readable program code configured to cause the client computer to execute a first process and to cause the server computer to execute a second process,
wherein the first process comprises:
(a) obtaining a scanned copy of the document including the document image and the authentication barcode;
(b) extracting authentication information encoded in the authentication barcode;
(c) generating a target document digest from the extracted authentication information;
(d) transmitting a verification request containing the target document digest to the server computer, wherein the verification request requests the server computer to verify the target document digest based on previously stored document digests;
wherein the second process comprises,
(e) receiving the verification request including the target document digest from the client;
(f) retrieving a corresponding stored document digest from a database;
(g) comparing the target document digest with the retrieved document digest to determine whether the verification is successful;
(h) transmitting a verification response to the client computer;
wherein the first process further comprises,
(i) receiving the verification response from the server computer;
(j) if the verification response indicates an unsuccessful verification, marking the document as having been altered; and
(k) if the verification response indicates a successful verification, authenticating the document using the authentication information to determine whether the document has been altered.

17. The computer program product of claim 16,
wherein the first process further comprises (l) obtaining a document ID from the scanned document;
wherein in steps (d) and (e) the verification request further includes the document ID; and
wherein step (f) includes retrieving a stored document digest from the database using the document ID as an index or search key.

18. The computer program product of claim 17, wherein step (l) includes extracting the document ID from the authentication barcode.

19. The computer program product of claim 16, wherein the document digest is a hash value.

20. The computer program product of claim 16, wherein step (k) includes decrypting the authentication information.
